(19) United States
(12) Patent Application Publication
(10) Pub. No.: US 2022/0400287 A1
(43) Pub. Date: Dec. 15, 2022

(54) Method and Apparatus for Signaling Horizontal Wraparound Motion Compensation in VR360 Video Coding

(71) Applicant: HFI Innovation Inc., Zhubei City, Hsinchu County (TW)

(72) Inventors: Chih-Yao CHIU, Hsinchu City (TW); Chun-Chia CHEN, Hsinchu City (TW); Chih-Wei HSU, Hsinchu City (TW); Ching-Yeh CHEN, Hsinchu City (TW); Yu-Wen HUANG, Hsinchu City (TW); Tzu-Der CHUANG, Hsinchu City (TW)

(21) Appl. No.: 17/775,968

(22) PCT Filed: Nov. 13, 2020
(86) PCT No.: PCT/CN2020/128572

§ 371 Date: May 11, 2022

Related U.S. Application Data
(60) Provisional application No. 62/935,665, filed on Nov. 15, 2019.
(60) Provisional application No. 62/941,934, filed on Nov. 29, 2019.

(51) Int. Cl. H04N 19/70; H04N 19/597; H04N 19/137; H04N 19/172; H04N 19/51

(52) U.S. Cl. CPC H04N 19/70; H04N 19/597; H04N 19/137; H04N 19/172; H04N 19/51

(57) ABSTRACT

Method and apparatus of coding VR360 video sequence are disclosed, wherein wraparound motion compensation is included as a coding tool. According to the method, a bitstream corresponding to encoded data of the VR360 video sequence is generated at an encoder side or received at a decoder side, where the bitstream comprises one or more PPS syntaxes related to wraparound motion compensation information in a PPS (Picture Parameter Set). The VR360 video sequence is encoded at the encoder side or decoded at the decoder side based on the wraparound motion compensation information.

### CROSS REFERENCE TO RELATED APPLICATIONS

The present invention claims priority to U.S. Provisional Patent Application Ser. No. 62/935,665, filed on Nov. 15, 2019 and U.S. Provisional Patent Application Ser. No. 62/941,934, filed on Nov. 29, 2019. The U.S. Provisional Patent Application is hereby incorporated by reference in its entirety.

### FIELD OF THE INVENTION

The present invention relates to picture processing for 360-degree virtual reality (VR360) pictures. In particular, the present invention relates to signaling wraparound motion compensation information for VR360 video coding.

### BACKGROUND AND RELATED ART

The 360-degree video, also known as immersive video is an emerging technology, which can provide “feeling as sensation of present”. The sense of immersion is achieved by surrounding a user with wrap-around scene covering a panoramic view, in particular, 360-degree field of view. The “feeling as sensation of present” can be further improved by stereographic rendering. Accordingly, the panoramic video is being widely used in Virtual Reality (VR) applications.

Immersive video involves the capturing a scene using multiple cameras to cover a panoramic view, such as 360-degree field of view. The immersive camera usually uses a panoramic camera or a set of cameras arranged to capture 360-degree field of view. Typically, two or more cameras are used for the immersive camera. All videos must be taken simultaneously and separate fragments (also called separate perspectives) of the scene are recorded. Furthermore, the set of cameras are often arranged to capture views horizontally, while other arrangements of the cameras are possible.

The 360-degree virtual reality (VR) pictures may be captured using a 360-degree spherical panoramic camera or multiple pictures arranged to cover all filed of views around 360 degrees. The three-dimensional (3D) spherical picture is difficult to process or store using the conventional picture/video processing devices. Therefore, the 360-degree VR pictures are often converted to a two-dimensional (2D) format using a 3D-to-2D projection method, such as EquiRectangular Projection (ERP) and CubeMap Projection (CMP). Besides the ERP and CMP projection formats, there are various other VR projection formats, such as OctaHedron Projection (OHP), icosahedron projection (ISP), Segmented Sphere Projection (SSP) and Rotated Sphere Projection (RSP) that are widely used in the field.

The VR360 video sequence usually requires more storage space than the conventional 2D video sequence. Therefore, video compression is often applied to VR360 video sequence to reduce the storage space for storage or the bit rate for streaming/transmission.

The High Efficiency Video Coding (HEVC) standard is developed under the joint video project of the ITU-T Video Coding Experts Group (VCEG) and the ISO/IEC Moving Picture Experts Group (MPEG) standardization organizations, and is especially with partnership known as the Joint Collaborative Team on Video Coding (JCT-VC). VR360 video sequences can be coded using HEVC. The emerging video coding standard development, named Versatile Video Coding (VVC), also includes coding techniques for VR360 video sequences. VVC supports reference picture resampling which is reviewed as follows.

Reference Picture Resampling

During the development of VVC, according to “Requirements for a Future Video Coding Standard”, “the standard shall support fast representation switching in the case of adaptive streaming services that offer multiple representations of the same content, each having different properties (e.g. spatial resolution or sample bit depth).” In real-time video communication, allowing resolution change within a coded video sequence without inserting an I picture can not only adapt the video data to dynamic channel conditions or user preference seamlessly, but also remove the beating effect caused by I pictures. A hypothetical example of Adaptive Resolution Change (ARC) with Reference Picture Resampling (RPR) is shown in FIG. 1, where the current picture (110) is predicted from reference pictures (Ref0 120 and Ref1 130) of different sizes. As shown in FIG. 1, reference picture Ref0 (120) has lower resolution than the current picture (110). In order to use reference picture Ref0 as a reference, Ref0 has to be up-scaled to the same resolution as the current picture. Reference picture Ref1 (130) has higher resolution than the current picture (110). In order to use reference picture Ref1 as a reference, Ref1 has to be down-scaled to the same resolution as the current picture.

To support the spatial scalability, the picture size of the reference picture can be different from the current picture, which is useful for streaming applications. Methods for supporting Reference Picture Resampling (RPR), which is also referred to as Adaptive Resolution Change (ARC), has been studied for inclusion into VVC specification. At the 14th JVET meeting in Geneva, several contributions on RPR were submitted and from discussion during the meeting.

Horizontal Wraparound Motion Compensation

The horizontal wraparound motion compensation has been proposed for inclusion in the VTM7 (J. Chen, et al., Algorithm description for Versatile Video Coding and Test Model 7 (VTM 7), Joint Video Experts Team (JVET) of ITU-T SG 16 WP 3 and ISO/IEC JTC 1/SC 29/WG 11 16th Meeting: Geneva, CH, 1-11 Oct. 2019, Document: JVET-P2002). The horizontal wraparound motion compensation is a 360-specific coding tool designed to improve the visual quality of reconstructed 360-degree video in the equi-rectangular (ERP) projection format. In conventional motion compensation, when a motion vector refers to samples beyond the picture boundaries of the reference picture, repetitive padding is applied to derive the values of the out-of-bounds samples by copying from the nearest neighbors of the corresponding picture boundary. For 360-degree video, this method of repetitive padding is not suitable, and could cause visual artefacts called “seam artefacts” in a reconstructed viewport video. Because a 360-degree video is captured on a sphere and inherently has no “boundary,” the reference samples that are outside the boundaries of a reference picture in the projected domain can always be obtained from neighboring samples in the spherical domain. For a general projection format, it may be difficult to derive the corresponding neighboring samples in the spherical domain, because it involves 2D-to-3D and 3D-to-2D coordinate conversion, as well as sample interpolation for fractional sample positions. This problem is much simpler for the left and right boundaries of the ERP projection format, since the spherical neighbors outside of the left picture boundary can be obtained from samples inside the right picture boundary, and vice versa. Given the wide usage of the ERP projection format, and the relative ease of implementation, the horizontal wraparound motion compensation was adopted in the VTM7 to improve the visual quality of 360-video coded in the ERP projection format.

In FIG. 2A, an example of a VR360 frame 210 corresponding to a world map in ERP format is shown. If the frame is treated as a conventional 2D image, reference block 220 covers an area 222 outside the frame boundary 224. This outside reference area would be considered unavailable. According to conventional motion compensation, the unavailable reference data may be generated using repetitive padding as shown in area 230 of FIG. 2A, which may cause seam artifact. The wraparound motion compensation adopted in VTM7, where the unavailable reference data may be generated using horizontal wraparound as shown in area 250 of FIG. 2B. Therefore, the unavailable area of the reference block 220 now use the wraparound reference data 242 to achieve proper motion compensation.

An example of the horizontal wraparound motion compensation process is described in Error! Reference source not found.3. When a part of the reference block is outside left (or right) boundary of the reference picture in the projected domain, instead of repetitive padding, the “out-of-boundary” part is taken from the corresponding spherical neighbors located within the reference picture toward the right (or left) boundary in the projected domain. Repetitive padding is only used for the top and bottom picture boundaries. As shown in FIG. 3, the current picture 310 is padded on left boundary (314) and right boundary (312) of the ERP picture (the area between left boundary (314) and right boundary (312). Similarly, the reference picture 320 is padded on left boundary (324) and right boundary (322) of the ERP picture (the area between left boundary (324) and right boundary (322). Block 330 corresponds to a current CU in the current picture 310 and block 340 corresponds to a co-located CU in the reference picture 320. The motion vector (MV) is used to locate the reference block 342, where part of the reference block (i.e., the area 344 filled with slant lines) is outside the reference picture boundary. The out-of-boundary area 344 can be generated from the wrapped-around reference block 346, where the wrapped-around reference block 346 is located by shifting the out-of-boundary area 344 by the ERP width horizontally.

As depicted in Error! Reference source not found., the horizontal wraparound motion compensation can be combined with the non-normative padding method often used in 360-degree video coding. In VVC, this is achieved by signaling a high level syntax element to indicate the wraparound offset, which should be set to the ERP picture width before padding; this syntax is used to adjust the position of horizontal wraparound accordingly. This syntax is not affected by the specific amount of padding on the left and right picture boundaries. Therefore, the syntax naturally supports asymmetric padding of the ERP picture to allow different left and right padding. The horizontal wraparound motion compensation provides more meaningful information for motion compensation when the reference samples are outside the left or right boundary of the reference picture. Under the 360-video common test condition (CTC), this tool improves compression performance not only in terms of rate-distortion performance, but also in terms of reduced seam artefacts and improved subjective quality of the reconstructed 360-degree video. The horizontal wraparound motion compensation can also be used for other single face projection formats with constant sampling density in the horizontal direction, such as adjusted equal-area projection in 360Lib.

The present invention addresses issues related to signaling the wraparound motion compensation information.

### BRIEF SUMMARY OF THE INVENTION

Method and apparatus of coding VR360 video sequence are disclosed, wherein wraparound motion compensation is included as a coding tool. According to the method, a bitstream corresponding to encoded data of the VR360 video sequence is generated at an encoder side or received at a decoder side, where the bitstream comprises one or more PPS syntaxes related to wraparound motion compensation information in a PPS (Picture Parameter Set). The VR360 video sequence is encoded at the encoder side or decoded at the decoder side based on the wraparound motion compensation information.

In one embodiment, the PPS syntaxes comprise a first PPS syntax corresponding to a PPS flag indicating whether the wraparound motion compensation is enabled for a target picture. For example, the first PPS syntax can be designated as pps_ref_wraparound_enabled_flag. In another embodiment, a second PPS syntax is included in the bitstream when the first PPS syntax indicates that the wraparound motion compensation is enabled for the target picture, where the second PPS syntax is related to a wraparound offset value. The second PPS syntax may represent the wraparound motion compensation offset value minus 1. For example, the second PPS syntax can be designated as pps_ref_wraparound_offset_minus1.

In one embodiment, the bitstream comprises one or more SPS syntaxes related to the wraparound motion compensation information in an SPS (Sequence Parameter Set). The SPS syntaxes may comprise a first SPS syntax corresponding to an SPS flag indicating whether the wraparound motion compensation is enabled for a target sequence. For example, the first SPS syntax can be designated as sps_ref_wraparound_enabled_flag.

### BRIEF DESCRIPTION OF THE DRAWINGS

FIG. 1 illustrates a hypothetical example of Adaptive Resolution Change (ARC) with Reference Picture Resampling (RPR), where a current picture is predicted from reference pictures (Ref0 and Ref1) of different sizes.

FIG. 2A illustrates an example of repetitive padding for unavailable reference data of a VR360 frame.

FIG. 2B illustrates an example of horizontal wraparound for unavailable reference data of a VR360 frame.

FIG. 3 illustrates an example of the horizontal wraparound motion compensation process.

FIG. 4 illustrates an exemplary block diagram of a system incorporating signaling wraparound motion compensation information according to an embodiment of the present invention.

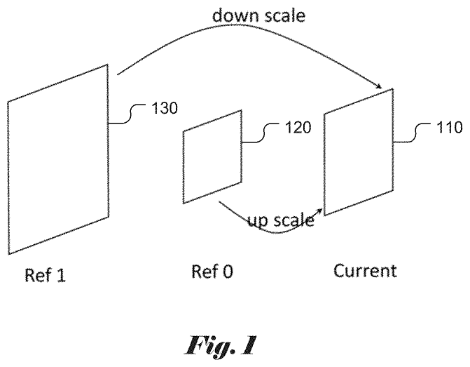

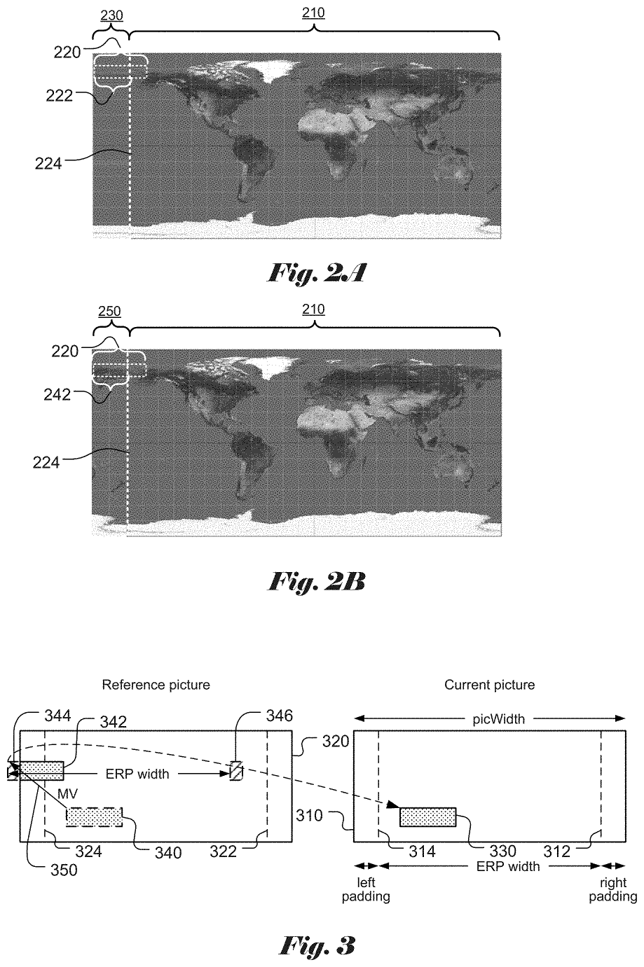

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention.

Reference throughout this specification to “one embodiment,” “an embodiment,” or similar language means that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In the description like reference numbers appearing in the drawings and description designate corresponding or like elements among the different views.

As described earlier, the VVC Draft 7 uses wrap-around motion compensation to handle reference picture areas outside the reference picture boundary. Furthermore, according to VVC Draft 7, a high level syntax element is signaled to indicate the wraparound offset, which is set to the ERP picture width before padding. However, the wraparound offset might be different for a group of pictures with different resolutions when RPR is enable. Another problem is that we cannot enable horizontal wraparound motion compensation as long as there is a picture referring to the SPS violates the conformance regulation. In order to solve the two problems mentioned above, embodiments according to the present invention modify the signaling of horizontal wraparound motion compensation information.

Method 1: Signaling Horizontal Wraparound Motion Compensation Information in PPS

In the VVC Draft 7,the signaling of horizontal wraparound motion compensation information is in the Sequence Parameter Set (SPS). Since the adaptive Resolution Change (ARC)/Reference Picture Resampling (RPR) allows the reference pictures to have different resolution, the signaling of horizontal wraparound motion compensation in SPS may cause incorrect reference data. Accordingly, one method to resolve this is to move the signaling of the horizontal wraparound motion compensation information from SPS to PPS (Picture Parameter Set).

Method 2: Signaling Horizontal Wraparound Motion Compensation Information in PPS with Conditions

In another method of the present invention, signaling the horizontal wraparound motion compensation information in the PPS is allowed when it is not in the SPS. If the horizontal wraparound motion compensation information is not in the PPS nor in the SPS, then it shall be in the PH (Picture Header).

In another embodiment, the information of wraparound offset is signaled in SPS when RPR is disabled. Furthermore, the information of wraparound offset is signaled in PPS when RPR is enabled.

Method 3: Supporting Horizontal Wraparound Motion Compensation Regardless of RPP Being Enabled or Disabled

According to Method 3, regardless whether RPR is enabled or disabled, only horizontal wraparound motion compensation is supported when there is no horizontal scaling and the picture size are the same between current picture and reference picture. Specifically, no horizontal scaling means that the PicOutputWidthL are the same between current picture and reference picture, where the PicOutputWidthL represents the width of the current picture after applying scaling window.

There can be four embodiments for Method 3 as listed below:

1. In one embodiment, the wraparound motion compensation is supported only when the PicOutputWidthL and picture size are the same between current picture and reference picture.

2. In one embodiment, the wraparound motion compensation is supported only when the PicOutputWidthL are the same between current picture and reference picture.

3. In one embodiment, the wraparound motion compensation is supported only when the PicOutputWidthL, PicOutputHeightL and picture size are the same between current picture and reference picture. 4. In one embodiment, the wraparound motion compensation is supported only when the PicOutputWidthL and PicOutputHeightL are the same between current picture and reference picture.

Method 4: Mutually Exclusive RPR and Horizontal Wraparound Motion Compensation

According to this method, reference picture resampling (RPR) and horizontal wraparound motion compensation are mutually exclusive. There can be two embodiments for Method 4:

1. The horizontal wraparound motion compensation is disabled in SPS when RPR is enabled or inter_layer_ref_pics_present_flag is equal to 1.

2. The horizontal wraparound motion compensation is disabled in SPS when RPR is enabled.

Some examples to implement the present invention based on the working draft are shown as follows.

According to Method 1, the working draft can be modified as shown in the following table.

TABLE 1
Exemplary sequence parameter set RBSP syntax
according to one embodiment of Method 1

| | |
|---|---|
| //sps_ref_wraparound_enabled_flag// | //u(1)// |
| //if( sps_ref_wraparound_enabled_flag )// | |
| //sps_ref_wraparound_offset_minus1// | //ue(v)// |

In the above table, texts between a pair of double slashes indicate deleted texts. As shown in the above table, the wraparound flag (i.e., sps_ref_wraparound_enabled_flag) and the wraparound offset information (i.e., sps_ref_wraparound_offset_minus1) are deleted in SPS. The information is signaled in the PPS according to one embodiment of the present invention as shown in the following table.

TABLE 2
Exemplary picture parameter set RBSP syntaxaccording
to one embodiment of Method 1

| | |
|---|---|
| pps_{—}ref_{—}wraparound_{—}enabled_{—}flag | u(1) |
| if( pps_{—}ref_{—}wraparound_{—}enabled_{—}flag ) | |
| pps_{—}ref_{—}wraparound_{—}offset_{—}minus1 | ue(v) |

In the above table, texts in Italic style indicate inserted texts. As shown in the above table, the wraparound flag (i.e., pps_ref_wraparound_enabled_flag) and the wraparound offset information (i.e., pps_ref_wraparound_offset_minus1) are inserted in PPS.

The picture parameter set RBSP semantics are described as follows:

pps_ref_wraparound_enabled_flag equal to 1 specifies that horizontal wrap-around motion compensation is applied in inter prediction. pps_ref_wraparound_enabled_flag equal to 0 specifies that horizontal wrap-around motion compensation is not applied. When the value of (CtbSizeY/MinCbSizeY+1) is larger than or equal to (pic_width_in_luma_samples/MinCbSizeY−1), the value of pps_ref_wraparound_enabled_flag shall be equal to 0.

pps_ref_wraparound_offset_minus1 plus 1 specifies the offset used for computing the horizontal wrap-around position in units of MinCbSizeY luma samples. The value of ref_wraparound_offset_minus1 shall be in the range of (CtbSizeY/MinCbSizeY)+1 to (pic_width_in_luma_samples/MinCbSizeY)−1, inclusive.

According to Method 2, the working draft in SPS can be modified as shown in the following table.

TABLE 3a
Exemplary sequence parameter set RBSP syntax according
to one embodiment of Method 2

| | |
|---|---|
| sps_ref_wraparound_enabled_present_flag | |
| if( sps_ref_wraparound_enabled_present_flag){ | |
| sps_ref_wraparound_enabled_flag | u(1) |
| if( sps_ref_wraparound_enabled_flag ){ | |
| sps_ref_wraparound_offset_minus1 | ue(v) |
| } | |
| } | |

According to another embodiment, an exemplary syntax design for wraparound information in SPS is shown in the following table. In the following table, SPS syntax sps_ref_wraparound_enabled_flag is signaled. If ref_pic_resampling_enabled_flag is not set and sps_ref_wraparound_enabled_flag is set, then syntax sps_ref_wraparound_offset_minus1 is signaled.

TABLE 3b
Exemplary sequence parameter set RBSP syntax according to another embodiment of
Method 2

| sps_ref_wraparound_enabled_flag | | u(1) |
|---|---|---|
| if(! | ref_pic_resampling_enabled_flag | |

| | |
|---|---|
| &&sps_ref_wraparound_enabled_flag){ | |
| sps_ref_wraparound_offset_minus1 | ue(v) |
| } | |
| } | |

As shown in the Table 3a, syntax sps_ref_wraparound_enabled_present_flag is introduced. Syntax sps_ref_wraparound_enabled_flag will be signaled only if the value of sps_ref_wraparound_enabled_present_flag is 1. The modification to PPS is the same as that in Method 1. In other words, the signaling of the wraparound information is also done in PPS as shown in the following table.

TABLE 4a
Exemplary picture parameter set RBSP syntax
according to one embodiment of Method 2

| | |
|---|---|
| pps_ref_wraparound_enabled_flag | u(1) |
| if( pps_ref_wraparound_enabled_flag ) | |
| pps_ref_wraparound_offset_minus1 | ue(v) |

According to another embodiment, syntax design similar to the Table 3b, is proposed. Signaling the wraparound information in PPS is shown in the following table.

TABLE 4b
Exemplary picture parameter set RBSP syntax
according to one embodiment of Method 2

| | |
|---|---|
| pps_ref_wraparound_present_flag | u(1) |
| if( pps_ref_wraparound_present_flag ) | |
| pps_ref_wraparound_offset_minus1 | ue(v) |

Following the syntax design of Table 3a and table 4a, the wraparound information can be signaled in the Picture Header (PH) as shown in the following table.

TABLE 5
Exemplary Picture Header RBSP syntax according to one embodiment
of Method 2

| | |
|---|---|
| if( sps_ref_wraparound_enabled_present_flag && | |
| ! sps_ref_wraparound_enabled_flag && | |
| ! pps_ref_wraparound_enabled_flag ){ | |
| ph_ref_wraparound_enabled_flag | u(1) |
| if( ph_ref_wraparound_enabled_flag ){ | |
| ph_ref_wraparound_offset_minus1 | ue(v) |
| } | |
| } | |

Sequence parameter set RBSP semantics in the above tables are described as follows.

sps_ref_wraparound_enabled_present_flag equal to 1 specifies that the presence of sps_ref_wraparound_enabled_flag in SPS. sps_ref_wraparound_enabled_present_flag equal to 0 specifies that the absence of sps_ref_wraparound_enabled_flag in SPS.

sps_ref_wraparound_enabled_flag equal to 1 specifies that horizontal wrap-around motion compensation is applied in inter prediction. sps_ref_wraparound_enabled_flag equal to 0 specifies that horizontal wrap-around motion compensation is not applied. When the value of (CtbSizeY/MinCbSizeY+1) is less than or equal to (pic_width_in_luma_samples/MinCbSizeY−1), where pic_width_in_luma_samples is the value of pic_width_in_luma_samples in any PPS that refers to the SPS, and the value of sps_ref_wraparound_enabled_flag shall be equal to 0.

ref_pic_resampling_enabled_flag equal to 1 specifies that reference picture resampling may be applied when decoding coded pictures in the CLVSs refer to the SPS. ref_pic_resampling_enabled_flag equal to 0 specifies that reference picture resampling is not applied when decoding pictures in CLVSs refer to the SPS.

sps_ref_wraparound_offset_minus1 plus 1 specifies the offset used for computing the horizontal wrap-around position in units of MinCbSizeY luma samples. The value of ref_wraparound_offset_minus1 shall be in the range of (CtbSizeY/MinCbSizeY)+1 to (pic_width_in_luma_samples/MinCbSizeY)−1, inclusive, where pic_width_in_luma_samples is the value of pic_width_in_luma_samples in any PPS that refers to the SPS.

Picture parameter set RBSP semantics in the above tables are described as follows.

pps_ref_wraparound_enabled_flag equal to 1 specifies that horizontal wrap-around motion compensation is applied in inter prediction for all pictures referring to the PPS. pps_ref_wraparound_enabled_flag equal to 0 specifies that horizontal wrap-around motion compensation is not applied. When the value of (CtbSizeY/MinCbSizeY+1) is larger than or equal to (pic_width_in_luma_samples/MinCbSizeY−1), the value of pps_ref_wraparound_enabled_flag shall be equal to 0.

When sps_ref_wraparound_enabled_present flag equal to 0 or sps_ref_wraparound_enabled_flag equal to 1, pps_ref_wraparound_enabled_flag shall be equal to 0.

pps_ref_wraparound_present_flag equal to 1 specifies that horizontal wrap-around motion compensation is applied in inter prediction for all pictures referring to the PPS. pps_ref_wraparound_present_flag equal to 0 specifies that horizontal wrap-around motion compensation is not applied. When the value of (CtbSizeY/MinCbSizeY+1) is larger than or equal to (pic_width_in_luma_samples/MinCbSizeY−1), the value of pps_ref_wraparound_present_flag shall be equal to 0. When ref_pic_resampling_enabled_flag equal to 0, pps_ref_wraparound_present_flag shall be equal to 0.

pps_ref_wraparound_offset_minus1 plus 1 specifies the offset used for computing the horizontal wrap-around position in units of MinCbSizeY luma samples. The value of ref_wraparound_offset_minus1 shall be in the range of (CtbSizeY/MinCbSizeY)+1 to (pic_width_in_luma_samples/MinCbSizeY)−1, inclusive.

Picture header RB SP semantics are described as follows.

ph_ref_wraparound_enabled_flag equal to 1 specifies that horizontal wrap-around motion compensation is applied in inter prediction for the picture referring to the PH. ph_ref_wraparound_enabled_flag equal to 0 specifies that horizontal wrap-around motion compensation is not applied for the picture referring to the PH.

ph_ref_wraparound_offset_minus1 plus 1 specifies the offset used for computing the horizontal wrap-around position in units of MinCbSizeY luma samples. The value of ref_wraparound_offset_minus1 shall be in the range of (CtbSizeY/MinCbSizeY)+1 to (pic_width_in_luma_samples/MinCbSizeY)−1, inclusive.

Implementation according to method 4 can be achieved using new syntax design or by modifying the syntax design of existing VVC Working Draft. Some examples based on the Working Draft are shown as follows.

In one embodiment, the Sequence parameter set RBSP syntax can be modified as shown in the following table.

TABLE 6a
Exemplary SPS RBSP syntax according to one embodiment of Method 4

| | | | |
|---|---|---|---|
| if(! | ref_pic_resampling_enabled_flag | && | ! |

| | |
|---|---|
| inter_layer_ref_pics_present_flag){ | |
| sps_ref_wraparound_enabled_flag | u(1) |
| if(sps_ref_wraparound_enabled _flag){ | |
| sps_ref_wraparound_offset_minus1 | ue(v) |
| } | |
| } | |

According to another embodiment, the value of inter_layer_ref_pics_present_flag is disregarded for signaling the wraparound information. The syntax design based on the VVC Working Draft as shown below.

TABLE 6b
Exemplary SPS RBSP syntax according to another embodiment of Method 4

| | |
|---|---|
| sps_ref_wraparound_enabled_flag | u(1) |
| if(! ref_pic_resampling_enabled_flag &&sps_ref_wraparound_enabled_flag){ | |
| sps_ref_wraparound_offset_minus1 | ue(v) |
| } | |
| } | |

Sequence parameter set RBSP semantics are described as follows. These semantics have the same meaning as the existing Working Draft.

sps_ref_wraparound_enabled_flag equal to 1 specifies that horizontal wrap-around motion compensation is applied in inter prediction. sps_ref_wraparound_enabled_flag equal to 0 specifies that horizontal wrap-around motion compensation is not applied. When the value of (CtbSizeY/MinCbSizeY+1) is less than or equal to (pic_width_in_luma_samples/MinCbSizeY−1), where pic_width_in_luma_samples is the value of pic_width_in_luma_samples in any PPS that refers to the SPS. When not present, the value of sps_ref_wraparound_enabled_flag shall be equal to 0.

ref_pic_resampling_enabled_flag equal to 1 specifies that reference picture resampling may be applied when decoding coded pictures in the CLVSs refer to the SPS. ref_pic_resampling_enabled_flag equal to 0 specifies that reference picture resampling is not applied when decoding pictures in CLVSs refer to the SPS.

sps_ref_wraparound_offset_minus1 plus 1 specifies the offset used for computing the horizontal wrap-around position in units of MinCbSizeY luma samples. The value of ref_wraparound_offset_minus1 shall be in the range of (CtbSizeY/MinCbSizeY)+1 to (pic_width_in_luma_samples/MinCbSizeY)−1, inclusive, where pic_width_in_luma_samples is the value of pic_width_in_luma_samples in any PPS that refers to the SPS.

inter_layer_ref_pics_present_flag equal to 0 specifies that no ILRP is used for inter prediction of any coded picture in the CLVS. inter_layer_ref_pics_flag_equal to 1 specifies that ILRPs may be used for inter prediction of one or more coded pictures in the CLVS. When sps_video_parameter_set_id is equal to 0, the value of inter_layer_ref_pics_present_flag is inferred to be equal to 0. When vps_independent_layer_flag[GeneralLayerIdx[nuh_layer_id]] is equal to 1, the value of inter_layer_ref_pics_present_flag shall be equal to 0.

According to another embodient, some constraints are imposed on the value of sps_ref_wraparound_enabled_flag instead of modifying the syntax table of SPS.

For example, the semantic of sps_ref_wraparound_enabled_flag can be modified as follows.

sps_ref_wraparound_enabled_flag equal to 1 specifies that horizontal wrap-around motion compensation is applied in inter prediction. sps_ref_wraparound_enabled_flag equal to 0 specifies that horizontal wrap-around motion compensation is not applied. When the value of (CtbSizeY/MinCbSizeY+1) is less than or equal to (pic_width_in_luma_samples/MinCbSizeY−1), where pic_width_in_luma_samples is the value of pic_width_in_luma_samples in any PPS that refers to the SPS. According to one embodiment of the present invention, when ref_pic_resampling_enabled_flag equals 1 or inter_layer_ref_pics_present_flag equals 1, the value of sps_ref_wraparound_enabled_flag shall be equal to 0.

When not present, the value of sps_ref_wraparound_enabled_flag shall be equal to 0.

Video encoders have to follow the foregoing syntax design so as to generate the legal bitstream, and video decoders are able to decode the bitstream correctly only if the parsing process is complied with the foregoing syntax design. When the syntax is skipped in the bitstream, encoders and decoders should set the syntax value as the inferred value to guarantee the encoding and decoding results are matched.

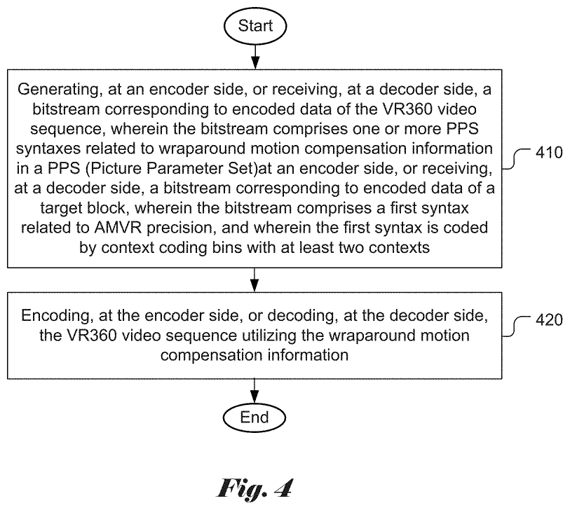

FIG. 4 illustrates an exemplary block diagram of a system incorporating signaling wraparound motion compensation information according to an embodiment of the present invention. The steps shown in the flowchart, as well as other following flowcharts in this disclosure, may be implemented as program codes executable on one or more processors (e.g., one or more CPUs) at the encoder side and/or the decoder side. The steps shown in the flowchart may also be implemented based hardware such as one or more electronic devices or processors arranged to perform the steps in the flowchart. According to this method, a bitstream corresponding to encoded data of the VR360 video sequence is generated at an encoder side or received at a decoder side in step 410, wherein the bitstream comprises one or more PPS syntaxes related to wraparound motion compensation information in a PPS (Picture Parameter Set). The VR360 video sequence is encoded at the encoder side or decoded at the decoder side based on the wraparound motion compensation information in step 420.

The flowchart shown above is intended for serving as examples to illustrate embodiments of the present invention. A person skilled in the art may practice the present invention by modifying individual steps, splitting or combining steps with departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more electronic circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method for coding a VR360 video sequence, wherein wraparound motion compensation is included as a coding tool, the method comprising:
generating, at an encoder side, or receiving, at a decoder side, a bitstream corresponding to encoded data of the VR360 video sequence, wherein the bitstream comprises one or more PPS syntaxes related to wraparound motion compensation information in a PPS (Picture Parameter Set); and
encoding, at the encoder side, or decoding, at the decoder side, the VR360 video sequence utilizing the wraparound motion compensation information.

2. The method of claim 1, wherein said one or more PPS syntaxes comprise a first PPS syntax corresponding to a PPS flag indicating whether the wraparound motion compensation is enabled for a target picture.

3. The method of claim 2, wherein the first PPS syntax is designated as pps_ref_wraparound_enabled_flag.

4. The method of claim 2, wherein a second PPS syntax is included in the bitstream when the first PPS syntax indicates that the wraparound motion compensation is enabled for the target picture, wherein the second PPS syntax is related to a wraparound offset value.

5. The method of claim 4, wherein the second PPS syntax represents the wraparound motion compensation offset value minus 1.

6. The method of claim 4, wherein the second PPS syntax is designated as pps_ref_wraparound_offset_minus1.

7. The method of claim 1, wherein the bitstream comprises one or more SPS syntaxes related to the wraparound motion compensation information in an SPS (Sequence Parameter Set).

8. The method of claim 7, wherein said one or more SPS syntaxes comprise a first SPS syntax corresponding to an SPS flag indicating whether the wraparound motion compensation is enabled for a target sequence.

9. The method of claim 8, wherein the first SPS syntax is designated as sps_ref_wraparound_enabled_flag.

10. An apparatus for coding a VR360 video sequence, wherein wraparound motion compensation is included as a coding tool, the apparatus comprising one or more electronic circuits or processors arranged to:
generate, at an encoder side, or receive, at a decoder side, a bitstream corresponding to encoded data of the VR360 video sequence, wherein the bitstream comprises one or more PPS syntaxes related to wraparound motion compensation information in a PPS (Picture Parameter Set); and
encode, at the encoder side, or decode, at the decoder side, the VR360 video sequence utilizing the wraparound motion compensation information.

11. The apparatus of claim 10, wherein said one or more PPS syntaxes comprise a first PPS syntax corresponding to a PPS flag indicating whether the wraparound motion compensation is enabled for a target picture.

12. The apparatus of claim 11, wherein the first PPS syntax is designated as pps_ref_wraparound_enabled_flag.

13. The apparatus of claim 11, wherein a second PPS syntax is included in the bitstream when the first PPS syntax indicates that the wraparound motion compensation is enabled for the target picture, wherein the second PPS syntax is related to a wraparound offset value.

14. The apparatus of claim 13, wherein the second PPS syntax represents the wraparound motion compensation offset value minus 1.

15. The apparatus of claim 13, wherein the second PPS syntax is designated as pps_ref_wraparound_offset_minus1.

16. The apparatus of claim 10, wherein the bitstream comprises one or more SPS syntaxes related to the wraparound motion compensation information in an SPS (Sequence Parameter Set).

17. The apparatus of claim 16, wherein said one or more SPS syntaxes comprise a first SPS syntax corresponding to an SPS flag indicating whether the wraparound motion compensation is enabled for a target sequence.

8. The apparatus of claim 17, wherein the first SPS syntax is designated as sps_ref_wraparound_enabled_flag.
